(19) United States
(12) Patent Application Publication
(10) Pub. No.: US 2025/0310590 A1
(43) Pub. Date: Oct. 2, 2025

(54) SYSTEMS AND METHODS FOR DISPLAYING PERSONALIZED STREAMING PLATFORM EVENT CONTENT IN NEAR REAL-TIME AT SCALE

(71) Applicant: Netflix, Inc., Los Gatos, CA (US)

(72) Inventors: Jeremy Kelly, Santa Clara, CA (US); Jennifer Jieun Shin, Huntington Beach, CA (US); James Patrick Isaacs, Cincinnati, OH (US); Kristopher Philip Range, Redmond, WA (US); Ankush Gulati, Fremont, CA (US); Jason Tu, San Jose, CA (US)

(21) Appl. No.: 18/622,815

(22) Filed: Mar. 29, 2024

(51) Int. Cl. H04N 21/431; H04L 65/60; H04N 21/2187; H04N 21/262; H04N 21/488

(52) U.S. Cl. CPC H04N 21/431; H04L 65/60; H04N 21/2187; H04N 21/26291; H04N 21/4882

(57) ABSTRACT

A computer-implemented method for enabling client devices to display personalized and state-specific updated content associated with a streaming platform event in near real-time as soon as the streaming platform event experiences a state change. For example, implementations described herein. For example, the method includes enabling client devices to subscribe to topics associated with the streaming platform event and causing the client devices to prefetch state-driven metadata associated with the streaming platform event. The method then includes sending low-latency update messages indicating that the streaming platform event has experienced a state change. These update messages cause the subscribed client devices to update content to reflect the state change associated with the streaming platform event. Various other methods, systems, and computer-readable media are also disclosed.

### BACKGROUND

Digital content streaming is an increasingly popular activity as viewers turn to digital content streaming platforms to watch movies and episodic content. Previously, digital content streaming was generally limited to pre-recorded content. Recently, digital content streaming platforms have evolved and now offer additional content such as interactive video games and live streaming events (e.g., events that stream live for simultaneous viewing in real-time).

The rise of live and interactive content, however, increases a need for nearly simultaneous client-side updates. To illustrate, a scheduled live streaming event may be associated with visual content (e.g., selectable artwork, previews, banners) that is displayed to viewers via their client devices. In some implementations, a digital content streaming platform may update what the viewers see based on a current state of the live streaming event to indicate that the live streaming event is “Going Live Tomorrow,” “Going Live in 10 Minutes,” “Live Now,” “Program Ended,” etc. Due to the nature of live streaming events, it may not be known ahead of time when any of these event states occur.

Sending update messages to the client devices regarding the updated state of the live streaming event generally causes spikes in computational resource consumption from which it is difficult to recover. For example, within a typical network communication protocol, informing the client devices of an updated state associated with a streaming platform event often causes a “thundering herd” of requests received by the digital content streaming platform for new displayable content (e.g., updated banners, icons, badges) associated with the updated state. This spike in requests often causes the streaming platform to have to update vast numbers of client devices simultaneously-leading to slow responses and a limited ability to serve personalized content.

### SUMMARY

As will be described in greater detail below, the present disclosure describes implementations that enable client devices to display personalized and state-specific updated content associated with a streaming platform event in near real-time as soon as the streaming platform event experiences a state change. For example, implementations include generating an update message based on a state update associated with a streaming platform event, identifying one or more subscribed devices associated with the streaming platform event, and broadcasting the update message to the one or more subscribed devices to cause a re-rendering of one or more prefetched user interface elements associated with the streaming platform event within a streaming platform application on the one or more subscribed devices.

In one or more implementations, the streaming platform event is a live streaming event. Additionally, some implementations further include causing the one or more subscribed devices to prefetch state-specific data associated with the streaming platform event. In at least one implementation, the state-specific data associated with the streaming platform event includes live event user interface elements, live event metadata, and a coordinated schedule associated with the streaming platform event.

In one or more implementations, generating the update message based on the state update includes generating a message reflecting a change to the coordinated schedule associated with the streaming platform event. Additionally, in one or more implementations, the state update associated with the streaming platform event includes current state metadata received from a live event monitoring service.

One or more implementations further include storing the update message, determining that an additional subscribed device came online during the streaming platform event, and broadcasting the update message to the additional subscribed device to cause the re-rendering of the one or more prefetched user interface elements associated with the streaming platform event within the streaming platform application on the additional subscribed device.

Additionally, one or more implementations further include receiving an additional state update indicating that the streaming platform event has concluded, generating an additional update message based on the additional state update, and broadcasting the additional update message to the one or more subscribed devices to cause a removal of the one or more prefetched user interface elements associated with the streaming platform event within the streaming platform application on the one or more subscribed devices.

Some examples described herein include a system with at least one physical processor and physical memory including computer-executable instructions that, when executed by the at least one physical processor, cause the at least one physical processor to perform various acts. In at least one example, the computer-executable instructions, when executed by the at least one physical processor, cause the at least one physical processor to perform acts including generating an update message based on a state update associated with a streaming platform event, identifying one or more subscribed devices associated with the streaming platform event, and broadcasting the update message to the one or more subscribed devices to cause a re-rendering of one or more prefetched user interface elements associated with the streaming platform event within a streaming platform application on the one or more subscribed devices.

In some examples, the above-described method is encoded as computer-readable instructions on a computer-readable medium. In one example, the computer-readable instructions, when executed by at least one processor of a computing device, cause the computing device to generate an update message based on a state update associated with a streaming platform event, identify one or more subscribed devices associated with the streaming platform event, and broadcast the update message to the one or more subscribed devices to cause a re-rendering of one or more prefetched user interface elements associated with the streaming platform event within a streaming platform application on the one or more subscribed devices.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings number of exemplary embodiments and are a part of the specification. Together with the following description, these drawings demonstrate and explain various principles of the present disclosure.

FIG. 1 illustrates an overview of a networking environment in which a near real-time system operates to cause client devices to display just-in-time, state-specific content in connection with a streaming platform event in accordance with one or more implementations.

FIG. 2 illustrates a flow diagram of a method for enabling near real-time state-driven updates to client-side content that is associated with streaming platform events in accordance with one or more implementations.

FIGS. 3 and 4 illustrate a streaming platform user interface including updated, state-specific user interface elements in accordance with one or more implementations.

FIG. 5 illustrates an overview of a prefetch phase and a near real-time update phase enacted by the near real-time system in accordance with one or more implementations.

FIG. 6 illustrates an overview of the near real-time system in accordance with one or more implementations.

FIG. 7 illustrates a block diagram of an exemplary content distribution ecosystem.

FIG. 8 illustrates a block diagram of an exemplary distribution infrastructure within the content distribution ecosystem shown in FIG. 7.

FIG. 9 illustrates a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

As discussed above, typical streaming platform communication frameworks are not equipped to adequately serve just-in-time, personalized, and state-specific content to viewer client devices. For example, under a typical content distribution architecture, a sudden state change associated with a streaming platform event (e.g., such as one associated with a live streaming event that may start late, have unexpected issues, end early, etc.) may be communicated to client devices. Due to the unexpected state change, typical streaming platforms may push generic content updates to viewer's client devices, but this generic content lacks personalization. Alternatively, the client devices may simultaneously issue requests for updated content that is specific to the new state of the streaming platform event and personalized to their viewers. This means that the streaming platform receives and tries to respond to a sudden, unexpected, and high number of simultaneous requests. These types of traffic bursts often overwhelm server resources leading to slow downs and bottlenecks within the streaming platform network.

In light of this, the present disclosure is generally directed to a system that enables client devices to display personalized and state-specific updated content associated with a streaming platform event almost as soon as the streaming platform event experiences a state change. For example, as will be discussed in greater detail below, the system described herein causes client devices to prefetch personalized and state-specific metadata (e.g., display content and event schedules that are personalized to a specific language, geographic area, etc.) associated with an upcoming streaming platform event. In one or more implementations, the described system allows the client devices to render streaming platform application user interface elements according to the prefetched event schedules with the personalized and state-specific display content. If there is an unscheduled state change (e.g., such as with a delayed start or the event running long), the described system generates and sends a low-latency update message based on the state change to the client devices that causes the client devices to automatically update or re-render user interface elements according to the state change. In at least one implementation, the described system enables prefetching and update message broadcasts based on client device topic subscriptions.

In this way, the described system avoids the “thundering herd” problem exhibited by typical network communication protocols that lead to peaks in computing resource consumption and corresponding response slow-downs and bottlenecks. For example, the described system prefetches high-cardinality, state-driven metadata to client devices such that unexpected state changes associated with streaming platform events can be quickly communicated and handled. Thus, while a typical network communication protocol results in slow-downs and unexpected delays in connection with streaming platform events, the system described herein embodies a low-latency agility that enables unexpected state changes to be reflected on client devices in near real-time.

Features from any of the implementations described herein may be used in combination with one another in accordance with the general principles described herein. These and other implementations, features, and advantages will be more fully understood upon reading the following detailed description in conjunction with the accompanying drawings and claims.

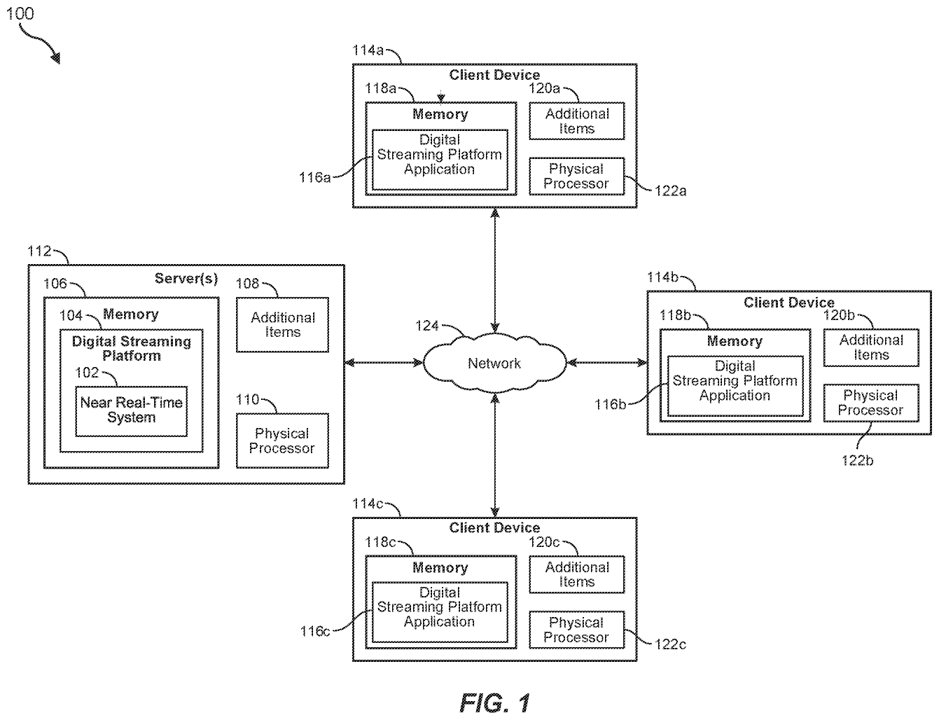

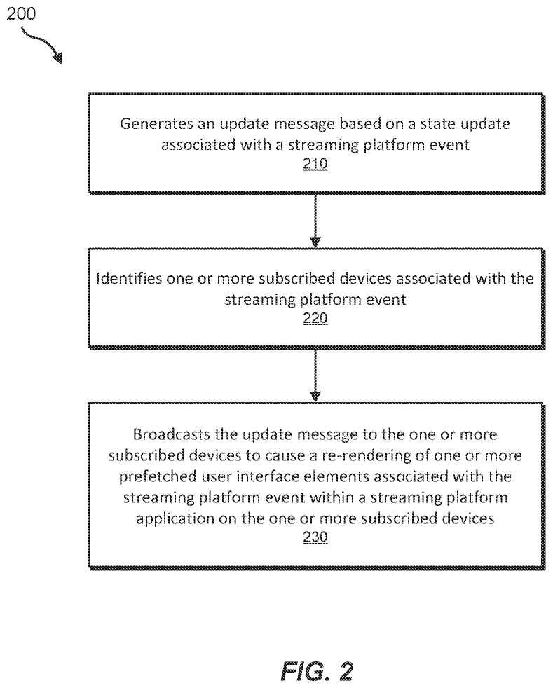

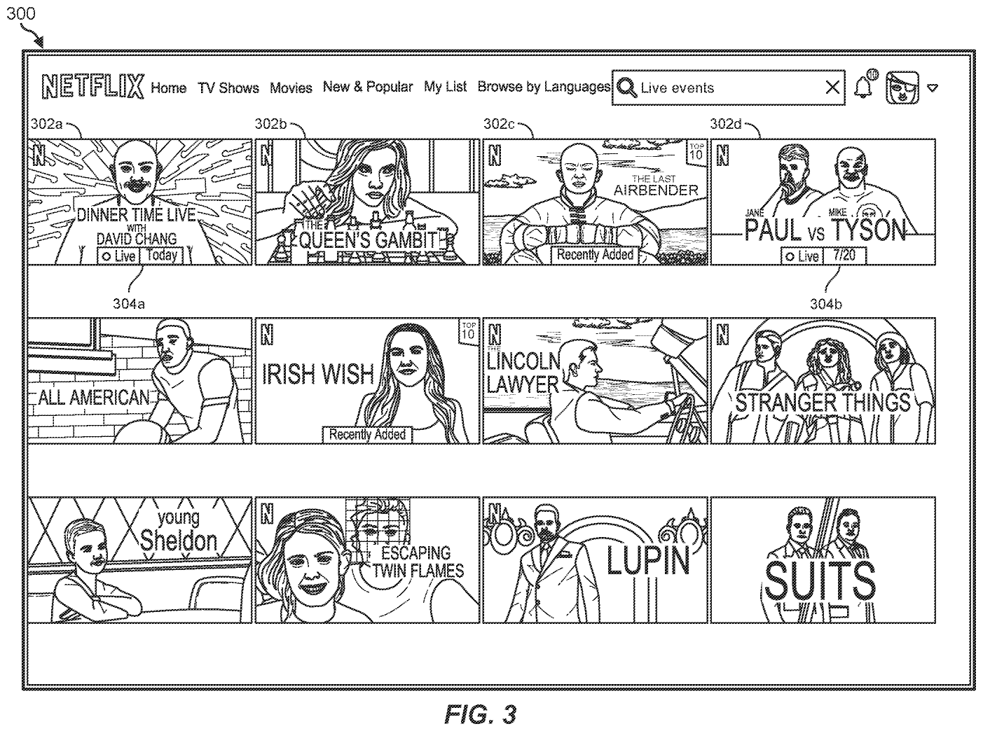

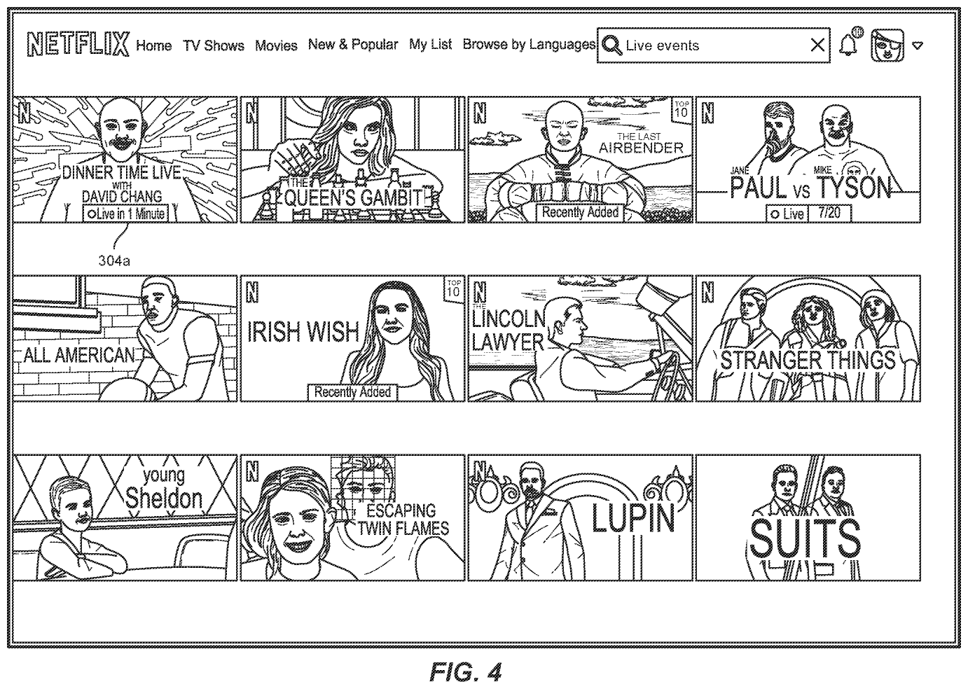

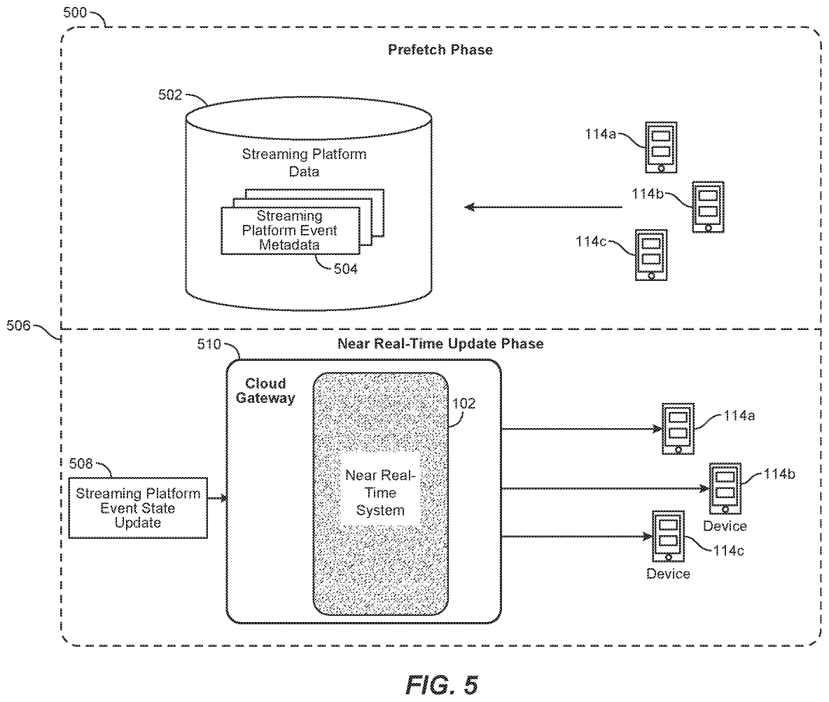

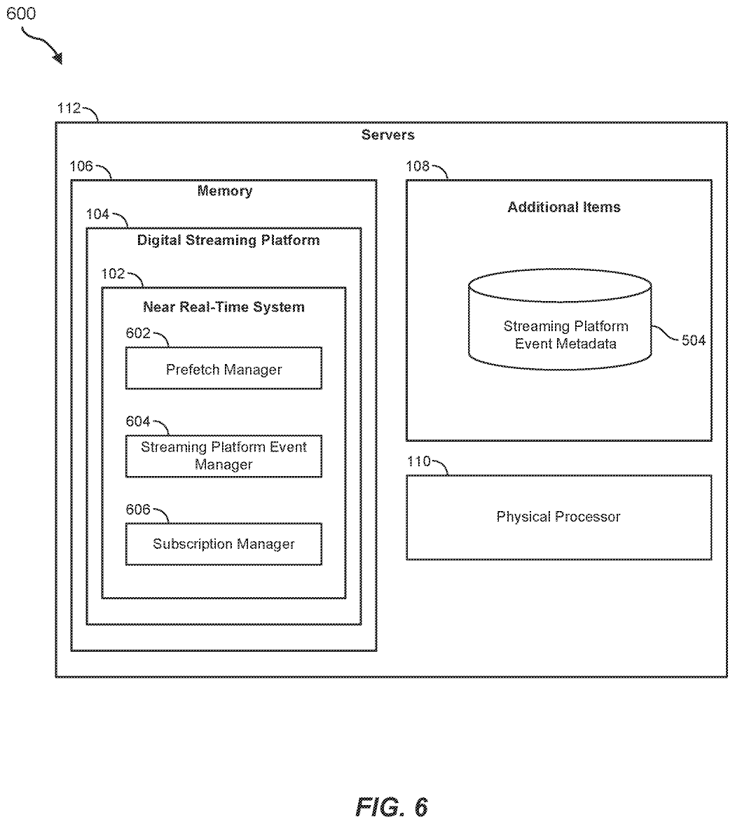

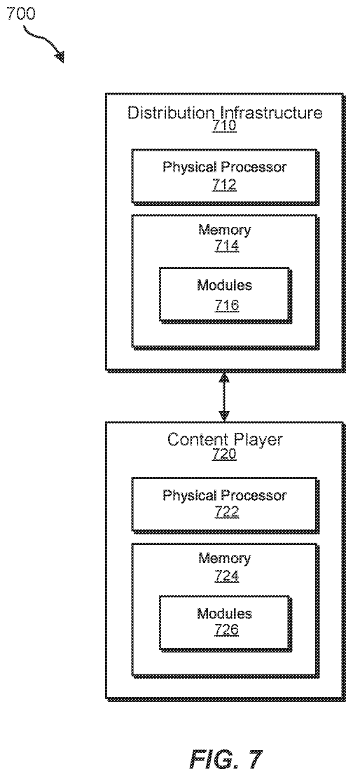

The following will provide, with reference to FIGS. 1-9, detailed description of a near real-time system that causes client devices to display just-in-time, state-specific content in connection with a streaming platform event. For example, FIG. 1 illustrates an overview of a networking environment in which a near real-time system operates. FIG. 2 illustrates a flow diagram of a method for enabling near real-time state-driven updates to client-side content that is associated with streaming platform events. FIGS. 3 and 4 illustrate a streaming platform user interface including updated, state-specific user interface elements. FIG. 5 illustrates an overview of a prefetch phase and a near real-time update phase enacted by the near real-time system. FIG. 6 illustrates an overview of additional features of the near real-time system. FIGS. 7-9 illustrate additional detail with regard to a content distribution system (e.g., a digital streaming platform).

As mentioned above, FIG. 1 illustrates an exemplary networking environment 100 implementing aspects of the present disclosure. For example, the networking environment 100 includes server(s) 112, client devices 114a, 114b, and 114c, and a network 124. As further shown, the server(s) 112 and the client devices 114a-114c include memories 106, 118a, 118b, and 118c, additional items 108, 120a, 120b, and 120c, and physical processors 110, 122a, 122b, and 122c, respectively.

In one or more implementations, as shown in FIG. 1, the client devices 114a-114c are devices that are capable of digital content item playback. For example, in some implementations, the client devices 114a-114c are any of smartphones, tablets, laptop computers, desktop computers, smart wearables, virtual reality headsets, and so forth. In at least one implementation any of the client devices 114a-114c are set-top devices that receive streamed input from the server(s) 112 and provide the streamed content to a television for playback. In one or more implementations, the client devices 114a-114c are further capable of playback live streamed events originating from the server(s) 112.

As further shown in FIG. 1, a near real-time system 102 is implemented as part of a digital streaming platform 104 within the memory 106 on the server(s) 112. In one or more implementations, the digital streaming platform 104 includes a subscription streaming service for providing digital media content to subscribers. In one or more examples, this digital media content includes non-interactive content such as movies and TV shows, as well as interactive content such as video games. In additional examples, this digital media content further includes live streamed events that are broadcast from the digital streaming platform 104 in real-time. Moreover, the digital streaming platform 104 also provides static information such as menus and selectable thumbnails associated with digital media items.

As further shown in FIG. 1, the client devices 114a-114c include digital streaming platform applications 116a, 116b, and 116c within the memories 118a-118c, respectively. In some implementations, the digital streaming platform applications 116a-116c include some or all of the functionality of the near real-time system 102. In at least one implementation, the digital streaming platform applications 116a-116c generate content requests and transmit these requests to the digital streaming platform 104. In some implementations, the digital streaming platform applications 116a-116c are native applications installed on the client devices 114a-114c. In additional implementations, the digital streaming platform applications 116a-116c are accessed via a web browser installed on the client devices 114a-114c.

As mentioned above, the client devices 114a-114c are communicatively coupled with the server(s) 112 through the network 124. In one or more implementations, the network 124 represents any type or form of communication network, such as the Internet, and includes one or more physical connections, such as a LAN, and/or wireless connections, such as a WAN. In some implementations, the network 124 represents a telecommunications carrier network. In at least one implementation, the network 124 represents combinations of networks.

Although FIG. 1 illustrates components of the exemplary networking environment 100 in one arrangement, other arrangements are possible. For example, in one implementation, the near real-time system 102 operates as a native application installed on any of the client devices 114a-114c. In another implementation, the near real-time system 102 operates across multiple servers. In additional implementations, the exemplary networking environment 100 includes any number of client devices across any number of users, regions, geofenced areas, countries, and so forth.

As mentioned above, FIG. 2 is a flow diagram of an exemplary computer-implemented method 200 for enabling near real-time state-driven updates to client-side content that is associated with streaming platform events. The steps shown in FIG. 2 may be performed by any suitable computer-executable code and/or computing system, including the system(s) illustrated in FIG. 6. In one example, each of the steps shown in FIG. 2 may represent an algorithm whose structure includes and/or is represented by multiple sub-steps, examples of which will be provided in greater detail below.

As illustrated in FIG. 2, at step 210 the near real-time system 102 generates an update message based on a state update associated with a streaming platform event. In one or more examples, the near real-time system 102 generates the update message reflecting a near real-time change to a live streaming event schedule that is prefetched by client devices that are subscribed to that live streaming event. As such, in one or more implementations the update message indicates metadata associated with a specific state change for the live streaming event and an indication of the previous state that is now invalidated. For example, a state including “Starting in 5 minutes” may be invalidated by an update message that indicates the live streaming event is “Starting in 10 minutes.”

As further illustrated in FIG. 2, at step 220 the near real-time system 102 identifies one or more subscribed devices associated with the streaming platform event. In one or more examples, the near real-time system 102 identifies the one or more subscribed devices as client devices associated with the digital streaming platform 104 that have subscribed to a live streaming event offered by the digital streaming platform 104. In addition to having subscribed to the live streaming event, the near real-time system 102 can identify client devices that satisfy other characteristics such as residing within a particular geographic area, being associated with a particular membership level, having a particular device-type, being associated with a particular language, etc.

As further illustrated in FIG. 2, at step 230 the near real-time system 102 broadcasts the update message to the one or more subscribed devices to cause a re-rendering of one or more prefetched user interface elements associated with the streaming platform event within a streaming platform application on the one or more subscribed devices. For example, in one or more implementations, the near real-time system 102 causes the subscribed devices to prefetch state driven metadata associated with a live streaming event. In one implementation, the near real-time system 102 causes the subscribed devices to prefetch this metadata in response to subscribing to the live streaming event. In one or more examples, the state driven metadata includes state specific user interface elements (e.g., banners, icons, badges, thumbnails, preview content). In at least one example, the state driven metadata further includes a live event schedule of planned live event state changes. As such, the near real-time system 102 sends the update message indicating that there is a change to the live event schedule that necessitates a change to one or more user interface elements within a streaming platform display on the subscribed client devices.

To further illustrate, FIGS. 3 and 4 show a streaming platform user interface 300 including a number of digital content item thumbnails, such as the digital content item thumbnails 302a, 302b, 302c, and 302d. In one or more implementations, the digital streaming platform 104 causes a client device (e.g., the client device 114a) to display user interfaces such as the streaming platform user interface 300 via the streaming platform application (e.g., digital streaming platform application 116a) installed thereon. In response to detected user interactions with the displayed digital content item thumbnails, the digital streaming platform application 116a can update the user interface or portions of the user interface to display additional information associated with the corresponding digital content item. In additional implementations, in response to detected user interactions with user interface elements, the digital streaming platform 104 can subscribe the client device to one or more topics including the live streaming event, open a user profile, initiate playback of digital content items, and so forth.

As further shown in FIG. 3, the digital streaming platform 104 further includes user interface elements that provide additional information associated with digital content items within the streaming platform user interface 300. For example, the digital streaming platform 104 (e.g., via the digital streaming platform application 116a) overlays user interface elements 304a, 304b on the digital content item thumbnails 302a and 302d, respectively. In one or more implementations, the user interface elements 304a, 304b reflect a current state associated with the corresponding digital content. To illustrate, the user interface element 304a reflects that the digital content associated with the digital content item thumbnail 302a (e.g., a live streaming event) will be starting “Today.” Similarly, the user interface element 304b reflects that the digital content associated with the digital content item thumbnails 302b (e.g., another live streaming event) will be starting on “7/20.”

In one or more implementations, these state specific user interface elements are prefetched by the client device 114a along with a live event schedule that indicates when the states associated with the live streaming event should change and which user interface elements should be re-rendered in light of those state changes. Live streaming events, however, often experience unexpected state changes due to technical difficulties, personnel problems, etc. As such, the near real-time system 102 determines when a state change has occurred, and communicates that change to the client device 114a in near-real time.

As shown in FIG. 4, upon receiving the update message associated with the state change, the client device 114a re-renders the user interface element 304a to reflect the state change. For example, the near real-time system 102 causes the digital streaming platform application 116a on the client device 114a to re-render the user interface element 304a (e.g., that previously state the live streaming event was starting “Today”) to indicate an updated state (e.g., that the live streaming event is now “Live in 1 Minute”). In one or more implementations, the near real-time system 102 causes the digital streaming platform application 116a to re-render the user interface element 304a according to a prefetched coordinating schedule associated with the live event that indicated when the state of the live event would change.

In at least one implementation, the near real-time system 102 generated and sent the update message to the client device 114a in response to determining that the triggering state change occurred outside of the prefetched coordinating schedule (i.e., the state change was unexpected). In that implementation, the near real-time system 102 utilizes the update message to override the prefetched coordinating schedule and cause the client device 114a to display the updated state-based user interface element 304a immediately. In one or more implementations, both versions of the user interface element 304a were part of the original prefetch performed by the client device 114a in association with the subscribed live streaming event, thereby allowing the client device 114a to re-render user interface element 304a to display the updated state without fetching an updated version of user interface element 304a from server 112 in real time.

While FIGS. 3 and 4 illustrate the near real-time system 102 causing state-

drive user interface updates on the client device 114a in association with a live streaming event, the near real-time system 102 can cause state-driven client changes in additional contexts as well. For example, in one implementation, the near real-time system 102 can cause state-driven user interface updates in association with cloud gaming events. To illustrate, the near real-time system 102 can generate and broadcast update messages to client devices that cause the client devices to update user interface elements to reflect in-game activity relative to a currently-active cloud-based game (e.g., “390k players online now,” “Tournament in 1 hour,” etc.)

In an additional implementation, the near real-time system 102 can cause state-driven updates on a client device beyond user interface updates. For example, the near real-time system 102 can generate and broadcast update messages to client devices that cause the client devices to shift from a “normal” state to a “troubleshooting” state wherein the client devices suspend specific functionalities, report data back to the digital streaming platform at higher levels of granularity, etc. To illustrate, in one example, the near real-time system 102 can generate and broadcast update messages to a specific type of client device (e.g., a specific make and model of television installed with the digital streaming platform application) that causes that type of client device to shift into a troubleshooting state and report highly granular debugging data back to the digital streaming platform 104. As such, the near real-time system 102 can cause client devices to display prefetched user interface elements based on an updated state of a live event, cloud game, etc. Additionally, the near real-time system 102 can also cause client devices to modify their functionality based on a communicated state.

FIG. 5 illustrates overviews of a prefetch phase 500 and a near real-time update phase 506 enacted by the near real-time system 102 when enabling client devices to display state-specific updated content associated with a streaming platform event in near real-time as soon as the streaming platform event experiences a state change. For example, during the prefetch phase 500, the near real-time system 102 causes the client devices 114a-114c to prefetch streaming platform event metadata 504 from streaming platform data 502 maintained by the digital streaming platform 104.

In one or more implementations, the near real-time system 102 causes the client devices 114a-114c to prefetch the streaming platform event metadata 504 in response to determining that the client devices 114a-114c are subscribed to one or more topics-such as the streaming platform event associated with the streaming platform event metadata 504. Additionally or alternatively, the near real-time system 102 causes the client devices 114a-114c to prefetch the streaming platform event metadata 504 in response to determining that the client devices 114a-114c are subscribed to one or more topics associated with specific digital streaming platform characteristics (e.g., a language subgroup, a geographic area subgroup, a particular viewer preference subgroup) that are connected to the streaming platform event associated with the streaming platform event metadata 504.

In one or more implementations, the streaming platform event metadata 504 associated with a particular streaming platform event includes a variety of personalized and/or state-driven user interface elements, one or more coordinated schedules associated with the streaming platform event, and other data associated with the streaming platform event. In more detail, the state-driven user interface elements can include banner elements, badge elements, icon elements, digital media previews (e.g., short digital films), and so forth. In one or more examples, the state-driven user interface elements are personalized to each of the client devices 114a-114c (e.g., include text in a particular language, include specific colors, include personalized animations). In at least one implementation, the state-driven user interface elements include multiple versions of the same banner, badge, or icon, where each version includes different state-based language (e.g., “Starting tomorrow,” “Starting in 1 Hour,” “Already Started,” “Ending Soon”).

In one or more implementations, the near real-time system 102 causes the client devices 114a-114c to prefetch the streaming platform event metadata 504 a predetermined amount of time prior to the associated streaming platform event beginning. In some implementations, the near real-time system 102 can invalidate streaming platform event metadata that has already been prefetched in response to determining that new metadata associated with the streaming platform event has been added to the streaming platform data 502. In that case, the near real-time system 102 initiates a new prefetch phase 500 with the client devices 114a-114c.

At some point either following the prefetch phase 500 or in tandem with the prefetch phase 500, the near real-time system 102 enters the near real-time update phase 506. During the near real-time update phase 506, the near real-time system 102 detects or determines that a streaming platform event state update 508 has occurred or has been received from within a cloud gateway 510. For example, the near real-time system 102 can receive the streaming platform event state update 508 indicating that a state change has occurred in connection with the streaming platform event. To illustrate, in one example, the streaming platform event state update 508 indicates that the streaming platform event state has changed from “Starting Soon” to “Starting Now.”

Upon receiving the streaming platform event state update 508, the near real-time system 102 generates an update message based on the streaming platform event state update 508. In one or more examples, the near real-time system 102 generates the update message as a low-latency network communication that indicates the state change or update associated with the streaming platform event. In some examples, the near real-time system 102 further generates the update message with an indication of the prefetched metadata on the client devices 114a-114c affected by the state change.

In one or more implementations, the near real-time system 102 broadcasts the generated update message to the client devices 114a-114c to cause the client devices 114a-114c to either render one or more user interface elements or re-render one or more user interface elements to indicate the current state of the streaming platform event. In one or more examples, the near real-time system 102 repeats the near real-time update phase 506 each time a state change is detected in connection with the streaming platform event.

As mentioned above, and as shown in FIG. 6, the near real-time system 102 performs various functions in connection with enabling client devices to display personalized and/or state-specific updated content associated with a streaming platform event in near real-time as soon as the streaming platform event experiences a state change. FIG. 6 is a block diagram 600 of the near real-time system 102 operating within the memory 106 of the server(s) 112 while performing these functions. As such, FIG. 6 provides additional detail with regard to these functions. For example, in one or more implementations as shown in FIG. 6, the near real-time system 102 includes a prefetch manager 602, a streaming platform event manager 604, and a subscription manager 606. As further shown in FIG. 6, the additional items 108 stores and maintains streaming platform event metadata 504.

In certain implementations, the near real-time system 102 represents one or more software applications, modules, or programs that, when executed by a computing device, may cause the computing device to perform one or more tasks. For example, and as will be described in greater detail below, one or more of the prefetch manager 602, the streaming platform event manager 604, and the subscription manager 606 may represent software stored and configured to run on one or more computing devices, such as the server(s) 112. One or more of the prefetch manager 602, the streaming platform event manager 604, or the subscription manager 606 of the near real-time system 102 shown in FIG. 6 may also represent all or portions of one or more special purpose computers to perform one or more tasks.

As mentioned above, and as shown in FIG. 6, the near real-time system 102 includes the prefetch manager 602. In one or more implementations, the prefetch manager 602 handles tasks associated with prefetching streaming platform event metadata 504, as discussed above with regard to FIG. 5. For example, the prefetch manager 602 can cause the client devices 114a-114c to prefetch the streaming platform event metadata 504 at a predetermined point prior to the streaming platform event. In some implementations, the prefetch manager 602 introduces jitter into the requests of the client devices 114a-114c such that the server(s) 112 does not experience a “thundering herd” of requests.

As discussed above, the prefetch manager 602 causes the client devices 114a-114c to prefetch streaming platform metadata that is both state-specific and personalized. As such, in one or more examples, the prefetch manager 602 manages the prefetching of metadata that reflects personalized language selections, personalized design selections, and other personalized configuration selections. Thus, the prefetch manager 602 enables this personalized metadata to be prefetched to the client devices 114a-114c so that it is ready “just-in-time” when needed at the client side.

Additionally, in one or more implementations, the prefetch manager 602 invalidates client-side metadata that has gone out-of-date. For example, the prefetch manager 602 determines when new streaming platform event metadata is available and identifies existing metadata that should be replaced. In at least one implementation, the prefetch manager 602 causes the client devices 114a-114c to invalidate the existing metadata and prefetch the new streaming platform event metadata. In one or more examples, the new streaming platform event metadata includes updated user interface display elements, updated coordinated schedules, etc.

As mentioned above, and as shown in FIG. 6, the near real-time system 102 includes the streaming platform event manager 604. In one or more implementations, the streaming platform event manager 604 tracks or detects state changes associated with streaming platform events. For example, the streaming platform event manager 604 receives messages (e.g., current state metadata) from one or more event-specific subsystems or live event monitoring services and analyzes the received messages to determine whether a state change has occurred. State changes, for example, can include when an event goes live, when an event completes, when content is marked as sensitive, and so forth.

In response to determining that a state change has occurred, the streaming platform event manager 604 further generates and broadcasts an update message for the client devices 114a-114c. As discussed above, the streaming platform event manager 604 generates a low-latency network communication that indicates the change in states and causes the client devices 114a-114c to re-render or remove user interface elements using the prefetched streaming platform event metadata 504 that is already stored on the client devices 114a-114c. In at least one implementation, the streaming platform event manager 604 leverages WebSocket communication protocols to broadcast update messages to the client devices 114a-114c.

In one or more implementations, the streaming platform event manager 604 generates and broadcasts update messages when a streaming platform event experiences a state change that is unexpected. For example, as discussed above, the prefetch manager 602 causes the client devices 114a-114c to prefetch one or more coordinated schedules associated with a streaming platform event. The streaming platform event, however, may experience a schedule change, a schedule delay, or other states that cannot be scheduled in advance. As such, in most implementations, the streaming platform event manager 604 allows the client devices 114a-114c to display personalized, state-specific user interface elements according to the prefetched coordinated schedule, and sends update messages that cause the client devices 114a-114c to re-render user interface elements when an unexpected or unplanned state change occurs. Similarly, in some examples, the streaming platform event manager 604 suppresses a planned-for state change when an event change or delay invalidates a scheduled state change.

In one or more implementations, the streaming platform event manager 604 accounts for subscribed client devices that tune in to a streaming platform event late. For example, the streaming platform event manager 604 keeps a cache of outgoing update messages to be delivered when user devices come online during an event-either late or intermittently.

The streaming platform event manager 604 then polls the user devices that are tuned in to the streaming platform event at regular intervals during the event to identify late comers or devices that have lost connection and come back online. In one or more examples, the streaming platform event manager 604 broadcasts one or more update messages from the cache to these additional client devices to cause the additional client devices to re-render prefetched user interface elements associated with the streaming platform event to ensure that users of those devices are seeing the correct state-based information associated with the event.

While many examples described herein include causing client devices 114a-114c to display just-in-time state-specific display elements during a live streaming event within the digital streaming platform 104, the streaming platform event manager 604 manages just-in-time state-specific updates associated with other types of state-driven events. To illustrate, another example includes the streaming platform event manager 604 enabling just-in-time notifications associated with a state change to a specific digital streaming platform 104 configuration value. In another example, the streaming platform event manager 604 enables one-to-one personalized messages between a service within the digital streaming platform 104 and a client device associated with a specific account. As such, streaming platform events can be live events or non-live events.

As mentioned above, and as shown in FIG. 6, the near real-time system 102 includes the subscription manager 606. In one or more implementations, the subscription manager 606 manages subscriptions associated with streaming platform events and identifies client devices that are subscribed to various topics in association with streaming platform events. For example, the subscription manager 606 enables the client devices 114a-114c to subscribe (e.g., via a GraphQL subscription) to one or more topics. In at least one implementation, the subscription manager 606 organizes the client devices 114a-114c into communication nodes based on their subscriptions. In response to receiving the subscriptions, the subscription manager 606 mints subscription keys based on a hash of subscription type and subscription parameters (i.e., meaning the key will be the same for identical subscriptions).

Later, when the streaming platform event manager 604 generates an update message associated with a streaming platform event, the subscription manager 606 uses targeting information associated with the streaming platform event to look up subscription keys and corresponding communication nodes. The subscription manager 606 then enables the streaming platform event manager 604 to broadcast the update message to the correct client devices via the identified subscription keys and communication nodes.

As shown in FIGS. 1 and 6, the server(s) 112 and the client devices 114a-114c include one or more physical processors, such as the physical processors 110 and 122a-122c, respectively. The physical processors 110 and 122a-122c generally represent any type or form of hardware-implemented processing unit capable of interpreting and/or executing computer-readable instructions. In one implementation, the physical processors 110 and 122a-122c access and/or modify one or more of the components of the near real-time system 102. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Additionally as shown in FIGS. 1 and 6, the server(s) 112 and the client devices 114a-114c include memories 106 and 118a-118c, respectively. In one or more implementations, the memories 106 and 118a-118c generally represent any type or form of volatile or non-volatile storage device or medium capable of storing data and/or computer- readable instructions. In one example, the memories 106 and 118a-118c store, load, and/or maintain one or more of the components of the near real-time system 102. Examples of the memories 106 and 118a-118c include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Moreover, as shown in FIG. 6, the server(s) 112 includes the additional items 108. On the server(s) 112, the additional items 108 include streaming platform event metadata 504. In one or more implementations, as discussed above, the streaming platform event metadata 504 includes coordinated schedules and personalized, state-specific metadata associated with a streaming platform event. In some implementations, the streaming platform event metadata 504 includes high cardinality values that are prefetched in advance of a streaming platform event.

In summary, the near real-time system 102 enables the display and/or update of personalized and state-specific content on a client device in near real-time as the state of streaming platform event changes. Where previous systems leveraged protocols that caused sudden, disruptive spikes and drains on system resources, the near real-time system 102 utilizes prefetching and low-latency update messages to cause client devices to re-render or otherwise update digital streaming platform application elements just-in-time. Due to the prefetching of critical elements, the near real-time system 102 enables these changes to occur in near real-time without spiking server request levels or causing service pauses and other bottlenecking.

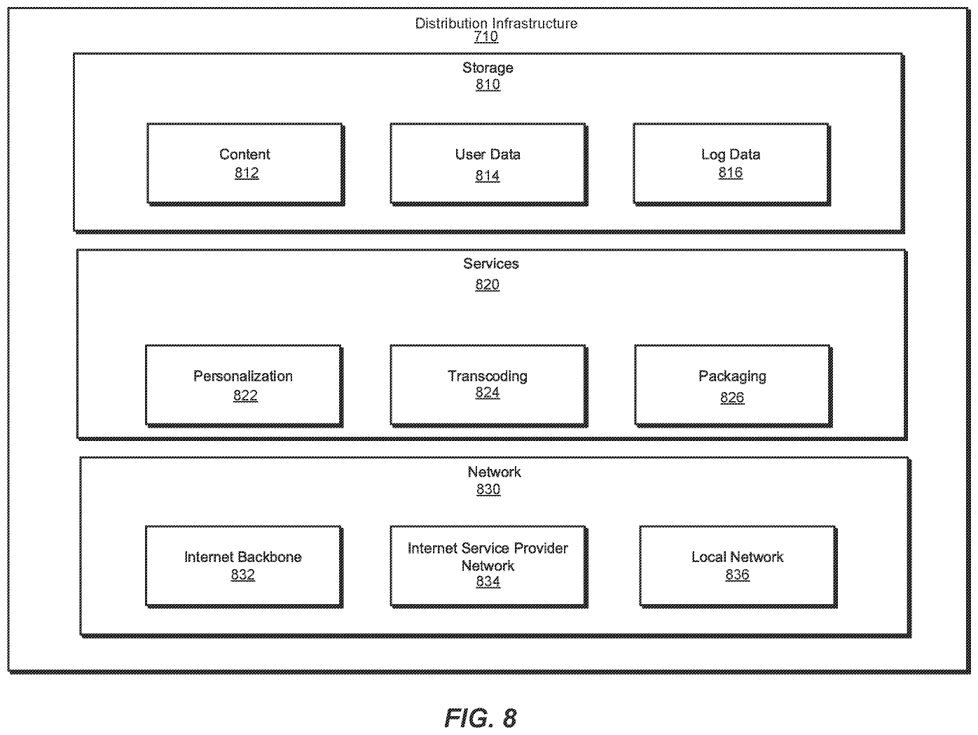

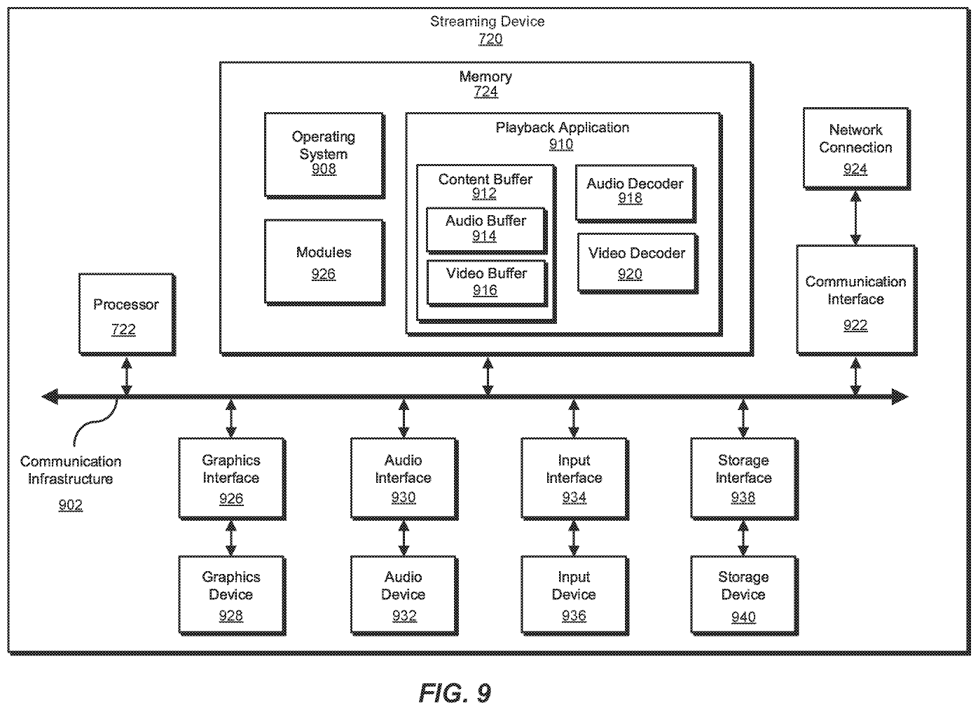

The following will provide, with reference to FIG. 7, detailed descriptions of exemplary ecosystems in which content is provisioned to end nodes and in which requests for content are steered to specific end nodes. The discussion corresponding to FIGS. 8 and 9 presents an overview of an exemplary distribution infrastructure and an exemplary content player used during playback sessions, respectively. These exemplary ecosystems and distribution infrastructures are implemented in any of the embodiments described above with reference to FIGS. 1-6.

FIG. 7 is a block diagram of a content distribution ecosystem 700 that includes a distribution infrastructure 710 in communication with a content player 720. In some embodiments, distribution infrastructure 710 is configured to encode data at a specific data rate and to transfer the encoded data to content player 720. Content player 720 is configured to receive the encoded data via distribution infrastructure 710 and to decode the data for playback to a user. The data provided by distribution infrastructure 710 includes, for example, audio, video, text, images, animations, interactive content, haptic data, virtual or augmented reality data, location data, gaming data, or any other type of data that is provided via streaming.

Distribution infrastructure 710 generally represents any services, hardware, software, or other infrastructure components configured to deliver content to end users. For example, distribution infrastructure 710 includes content aggregation systems, media transcoding and packaging services, network components, and/or a variety of other types of hardware and software. In some cases, distribution infrastructure 710 is implemented as a highly complex distribution system, a single media server or device, or anything in between. In some examples, regardless of size or complexity, distribution infrastructure 710 includes at least one physical processor 712 and memory 714. One or more modules 716 are stored or loaded into memory 714 to enable adaptive streaming, as discussed herein.

Content player 720 generally represents any type or form of device or system capable of playing audio and/or video content that has been provided over distribution infrastructure 710. Examples of content player 720 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 710, content player 720 includes a physical processor 722, memory 724, and one or more modules 726. Some or all of the adaptive streaming processes described herein is performed or enabled by modules 726, and in some examples, modules 716 of distribution infrastructure 710 coordinate with modules 726 of content player 720 to provide adaptive streaming of digital content.

In certain embodiments, one or more of modules 716 and/or 726 in FIG. 7 represent one or more software applications or programs that, when executed by a computing device, cause the computing device to perform one or more tasks. For example, and as will be described in greater detail below, one or more of modules 716 and 726 represent modules stored and configured to run on one or more general-purpose computing devices. One or more of modules 716 and 726 in FIG. 7 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 712 and 722 generally represent any type or form of hardware-implemented processing unit capable of interpreting and/or executing computer-readable instructions. In one example, physical processors 712 and 722 access and/or modify one or more of modules 716 and 726, respectively. Additionally or alternatively, physical processors 712 and 722 execute one or more of modules 716 and 726 to facilitate adaptive streaming of digital content. Examples of physical processors 712 and 722 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 714 and 724 generally represent any type or form of volatile or non-volatile storage device or medium capable of storing data and/or computer-readable instructions. In one example, memory 714 and/or 724 stores, loads, and/or maintains one or more of modules 716 and 726. Examples of memory 714 and/or 724 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 8 is a block diagram of exemplary components of distribution infrastructure 710 according to certain embodiments. Distribution infrastructure 710 includes storage 810, services 820, and a network 830. Storage 810 generally represents any device, set of devices, and/or systems capable of storing content for delivery to end users. Storage 810 includes a central repository with devices capable of storing terabytes or petabytes of data and/or includes distributed storage systems (e.g., appliances that mirror or cache content at Internet interconnect locations to provide faster access to the mirrored content within certain regions). Storage 810 is also configured in any other suitable manner.

As shown, storage 810 may store a variety of different items including content 812, user data 814, and/or log data 816. Content 812 includes television shows, movies, video games, user-generated content, and/or any other suitable type or form of content. User data 814 includes personally identifiable information (PII), payment information, preference settings, language and accessibility settings, and/or any other information associated with a particular user or content player. Log data 816 includes viewing history information, network throughput information, and/or any other metrics associated with a user's connection to or interactions with distribution infrastructure 710.

Services 820 includes personalization services 822, transcoding services 824, and/or packaging services 826. Personalization services 822 personalize recommendations, content streams, and/or other aspects of a user's experience with distribution infrastructure 710. Transcoding services 824 compress media at different bitrates which, as described in greater detail below, enable real-time switching between different encodings. Packaging services 826 package encoded video before deploying it to a delivery network, such as network 830, for streaming.

Network 830 generally represents any medium or architecture capable of facilitating communication or data transfer. Network 830 facilitates communication or data transfer using wireless and/or wired connections. Examples of network 830 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 830 includes an Internet backbone 832, an internet service provider network 834, and/or a local network 836. As discussed in greater detail below, bandwidth limitations and bottlenecks within one or more of these network segments triggers video and/or audio bit rate adjustments.

FIG. 9 is a block diagram of an exemplary implementation of content player 720 of FIG. 7. Content player 720 generally represents any type or form of computing device capable of reading computer-executable instructions. Content player 720 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 9, in addition to processor 722 and memory 724, content player 720 includes a communication infrastructure 902 and a communication interface 922 coupled to a network connection 924. Content player 720 also includes a graphics interface 926 coupled to a graphics device 928, an audio interface 930 coupled to an audio device 932, an input interface 934 coupled to an input device 936, and a storage interface 938 coupled to a storage device 940.

Communication infrastructure 902 generally represents any type or form of infrastructure capable of facilitating communication between one or more components of a computing device. Examples of communication infrastructure 902 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 724 generally represents any type or form of volatile or non-volatile storage device or medium capable of storing data and/or other computer-readable instructions. In some examples, memory 724 stores and/or loads an operating system 908 for execution by processor 722. In one example, operating system 908 includes and/or represents software that manages computer hardware and software resources and/or provides common services to computer programs and/or applications on content player 720.

Operating system 908 performs various system management functions, such as managing hardware components (e.g., graphics interface 926, audio interface 930, input interface 934, and/or storage interface 938). Operating system 908 also provides process and memory management models for playback application 910. The modules of playback application 910 includes, for example, a content buffer 912, an audio decoder 918, and a video decoder 920.

Playback application 910 is configured to retrieve digital content via communication interface 922 and play the digital content through graphics interface 926 and audio interface 930. Graphics interface 926 is configured to transmit a rendered video signal to graphics device 928. Audio interface 930 is configured to transmit a rendered audio signal to audio device 932. In normal operation, playback application 910 receives a request from a user to play a specific title or specific content. Playback application 910 then identifies one or more encoded video and audio streams associated with the requested title.

In one embodiment, playback application 910 begins downloading the content associated with the requested title by downloading sequence data encoded to the lowest audio and/or video playback bitrates to minimize startup time for playback. The requested digital content file is then downloaded into content buffer 912, which is configured to serve as a first-in, first-out queue. In one embodiment, each unit of downloaded data includes a unit of video data or a unit of audio data. As units of video data associated with the requested digital content file are downloaded to the content player 720, the units of video data are pushed into the content buffer 912. Similarly, as units of audio data associated with the requested digital content file are downloaded to the content player 720, the units of audio data are pushed into the content buffer 912. In one embodiment, the units of video data are stored in video buffer 916 within content buffer 912 and the units of audio data are stored in audio buffer 914 of content buffer 912.

A video decoder 920 reads units of video data from video buffer 916 and outputs the units of video data in a sequence of video frames corresponding in duration to the fixed span of playback time. Reading a unit of video data from video buffer 916 effectively de-queues the unit of video data from video buffer 916. The sequence of video frames is then rendered by graphics interface 926 and transmitted to graphics device 928 to be displayed to a user.

An audio decoder 918 reads units of audio data from audio buffer 914 and outputs the units of audio data as a sequence of audio samples, generally synchronized in time with a sequence of decoded video frames. In one embodiment, the sequence of audio samples is transmitted to audio interface 930, which converts the sequence of audio samples into an electrical audio signal. The electrical audio signal is then transmitted to a speaker of audio device 932, which, in response, generates an acoustic output.

In situations where the bandwidth of distribution infrastructure 710 is limited and/or variable, playback application 910 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 926 is configured to generate frames of video data and transmit the frames of video data to graphics device 928. In one embodiment, graphics interface 926 is included as part of an integrated circuit, along with processor 722. Alternatively, graphics interface 926 is configured as a hardware accelerator that is distinct from (i.e., is not integrated within) a chipset that includes processor 722.

Graphics interface 926 generally represents any type or form of device configured to forward images for display on graphics device 928. For example, graphics device 928 is fabricated using liquid crystal display (LCD) technology, cathode-ray technology, and light-emitting diode (LED) display technology (either organic or inorganic). In some embodiments, graphics device 928 also includes a virtual reality display and/or an augmented reality display. Graphics device 928 includes any technically feasible means for generating an image for display. In other words, graphics device 928 generally represents any type or form of device capable of visually displaying information forwarded by graphics interface 926.

As illustrated in FIG. 9, content player 720 also includes at least one input device 936 coupled to communication infrastructure 902 via input interface 934. Input device 936 generally represents any type or form of computing device capable of providing input, either computer or human generated, to content player 720. Examples of input device 936 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 720 also includes a storage device 940 coupled to communication infrastructure 902 via a storage interface 938. Storage device 940 generally represents any type or form of storage device or medium capable of storing data and/or other computer-readable instructions. For example, storage device 940 is a magnetic disk drive, a solid-state drive, an optical disk drive, a flash drive, or the like. Storage interface 938 generally represents any type or form of interface or device for transferring data between storage device 940 and other components of content player 720.

### EXAMPLE EMBODIMENTS

Example 1: A computer-implemented method that enables client devices to display state-specific updated content associated with a streaming platform event in near real-time as soon as the streaming platform event experiences a state change. For example, the method may include generating an update message based on a state update associated with a streaming platform event, identifying one or more subscribed devices associated with the streaming platform event, and broadcasting the update message to the one or more subscribed devices to cause a re-rendering of one or more prefetched user interface elements associated with the streaming platform event within a streaming platform application on the one or more subscribed devices.

Example 2: The computer-implemented method of Example 1, wherein the streaming platform event is a live streaming event.

Example 3: The computer-implemented method of any of Examples 1 and 2, further including causing the one or more subscribed devices to prefetch state-specific data associated with the streaming platform event.

Example 4: The computer-implemented method of any of Examples 1-3, wherein the state-specific data associated with the streaming platform event includes live event user interface elements, live event metadata, and a coordinated schedule associated with the streaming platform event.

Example 5: The computer-implemented method of any of Examples 1-4, wherein generating the update message based on the state update includes generating a message reflecting a change to the coordinated schedule associated with the streaming platform event.

Example 6: The computer-implemented method of any of Examples 1-5, wherein the state update associated with the streaming platform event includes current state metadata received from a live event monitoring service.

Example 7: The computer-implemented method of any of Examples 1-6, further including storing the update message, determining that an additional subscribed device came online during the streaming platform event, and broadcasting the update message to the additional subscribed device to cause the re-rendering of the one or more prefetched user interface elements associated with the streaming platform event within the streaming platform application on the additional subscribed device.

Example 8: The computer-implemented method of any of Examples 1-7, further including receiving an additional state update indicating that the streaming platform event has concluded, generating an additional update message based on the additional state update, and broadcasting the additional update message to the one or more subscribed devices to cause a removal of the one or more prefetched user interface elements associated with the streaming platform event within the streaming platform application on the one or more subscribed devices.

In some examples, a system may include at least one processor and a physical memory including computer-executable instructions that, when executed by the at least one processor, cause the at least one processor to perform various acts. For example, the computer-executable instructions may cause the at least one processor to perform acts including generating an update message based on a state update associated with a streaming platform event, identifying one or more subscribed devices associated with the streaming platform event, and broadcasting the update message to the one or more subscribed devices to cause a re-rendering of one or more prefetched user interface elements associated with the streaming platform event within a streaming platform application on the one or more subscribed devices.

In some examples, a method may be encoded as non-transitory, computer-readable instructions on a computer-readable medium. In one example, the computer-readable instructions, when executed by at least one processor of a computing device, cause the computing device to generate an update message based on a state update associated with a streaming platform event, identify one or more subscribed devices associated with the streaming platform event, and broadcast the update message to the one or more subscribed devices to cause a re-rendering of one or more prefetched user interface elements associated with the streaming platform event within a streaming platform application on the one or more subscribed devices.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of,” Finally, for ease of use, the terms “including” and “having” (and their derivatives), as used in the specification and claims, are interchangeable with and have the same meaning as the word “comprising.”

What is claimed is:

1. A computer-implemented method comprising:
generating an update message based on a state update associated with a streaming platform event;
identifying one or more subscribed devices associated with the streaming platform event; and
broadcasting the update message to the one or more subscribed devices to cause a re-rendering of one or more prefetched user interface elements associated with the streaming platform event within a streaming platform application on the one or more subscribed devices.

2. The computer-implemented method of claim 1, wherein the streaming platform event is a live streaming event.

3. The computer-implemented method of claim 1, further comprising causing the one or more subscribed devices to prefetch state-specific data associated with the streaming platform event.

4. The computer-implemented method of claim 3, wherein the state-specific data associated with the streaming platform event comprises live event user interface elements, live event metadata, and a coordinated schedule associated with the streaming platform event.

5. The computer-implemented method of claim 4, wherein generating the update message based on the state update comprises generating a message reflecting a change to the coordinated schedule associated with the streaming platform event.

6. The computer-implemented method of claim 1, wherein the state update associated with the streaming platform event comprises current state metadata received from a live event monitoring service.

7. The computer-implemented method of claim 1, further comprising:
storing the update message;
determining that an additional subscribed device came online during the streaming platform event; and
broadcasting the update message to the additional subscribed device to cause the re-rendering of the one or more prefetched user interface elements associated with the streaming platform event within the streaming platform application on the additional subscribed device.

8. The computer-implemented method of claim 1, further comprising:
receiving an additional state update indicating that the streaming platform event has concluded;
generating an additional update message based on the additional state update; and
broadcasting the additional update message to the one or more subscribed devices to cause a removal of the one or more prefetched user interface elements associated with the streaming platform event within the streaming platform application on the one or more subscribed devices.

9. A system comprising:
at least one physical processor; and
physical memory comprising computer-executable instructions that, when executed by the at least one physical processor, cause the at least one physical processor to perform acts comprising:
generating an update message based on a state update associated with a streaming platform event;
identifying one or more subscribed devices associated with the streaming platform event; and
broadcasting the update message to the one or more subscribed devices to cause a re-rendering of one or more prefetched user interface elements associated with the streaming platform event within a streaming platform application on the one or more subscribed devices.

10. The system of claim 9, wherein the streaming platform event is a live streaming event.

11. The system of claim 9, further comprising computer-executable instruction that, when executed by the at least one physical processor, cause the at least one physical processor to cause the one or more subscribed devices to prefetch state-specific data associated with the streaming platform event.

12. The system of claim 11, wherein the state-specific data associated with the streaming platform event comprises live event user interface elements, live event metadata, and a coordinated schedule associated with the streaming platform event.

13. The system of claim 12, wherein generating the update message based on the state update comprises generating a message reflecting a change to the coordinated schedule associated with the streaming platform event.

14. The system of claim 9, wherein the state update associated with the streaming platform event comprises current state metadata received from a live event monitoring service.

15. The system of claim 9, further comprising computer-executable instruction that, when executed by the at least one physical processor, cause the at least one physical processor to perform acts comprising:
storing the update message;
determining that an additional subscribed device came online during the streaming platform event; and
broadcasting the update message to the additional subscribed device to cause the re-rendering of the one or more prefetched user interface elements associated with the streaming platform event within the streaming platform application on the additional subscribed device.

16. The system of claim 9, further comprising computer-executable instruction that, when executed by the at least one physical processor, cause the at least one physical processor to perform acts comprising:
receiving an additional state update indicating that the streaming platform event has concluded;
generating an additional update message based on the additional state update; and
broadcasting the additional update message to the one or more subscribed devices to cause a removal of the one or more prefetched user interface elements associated with the streaming platform event within the streaming platform application on the one or more subscribed devices.

17. A non-transitory computer-readable medium comprising one or more computer-executable instructions that, when executed by at least one processor of a computing device, cause the computing device to:
generate an update message based on a state update associated with a streaming platform event;
identify one or more subscribed devices associated with the streaming platform event; and
broadcast the update message to the one or more subscribed devices to cause a re-rendering of one or more prefetched user interface elements associated with the streaming platform event within a streaming platform application on the one or more subscribed devices.

18. The non-transitory computer-readable medium of claim 17, further comprising one or more computer executable instructions that, when executed by the at least one processor of the computing device, cause the computing device to cause the one or more subscribed devices to prefetch state-specific data associated with the streaming platform event.

19. The non-transitory computer-readable medium of claim 17, further comprising one or more computer executable instructions that, when executed by the at least one processor of the computing device, cause the computing device to:
store the update message;
determine that an additional subscribed device came online during the streaming platform event; and
broadcast the update message to the additional subscribed device to cause the re-rendering of the one or more prefetched user interface elements associated with the streaming platform event within the streaming platform application on the additional subscribed device.

20. The non-transitory computer-readable medium of claim 17, further comprising one or more computer executable instructions that, when executed by the at least one processor of the computing device, cause the computing device to:
receive an additional state update indicating that the streaming platform event has concluded;
generate an additional update message based on the additional state update; and
broadcast the additional update message to the one or more subscribed devices to cause a removal of the one or more prefetched user interface elements associated with the streaming platform event within the streaming platform application on the one or more subscribed devices.
